(19) United States
(12) Patent Application Publication
(10) Pub. No.: US 2026/0180948 A1
(43) Pub. Date: Jun. 25, 2026

(54) INFORMATION PROCESSING APPARATUS AND INFORMATION PROCESSING METHOD

(71) Applicant: CANON KABUSHIKI KAISHA, Tokyo (JP)

(72) Inventor: MASAKI OTAKI, Kanagawa (JP)

(21) Appl. No.: 19/427,265

(22) Filed: Dec. 19, 2025

(30) Foreign Application Priority Data
Dec. 25, 2024 (JP) 2024-228433

(51) Int. Cl. H04L 51/21; G06F 40/279

(52) U.S. Cl. CPC H04L 51/21; G06F 40/279

(57) ABSTRACT

An information processing apparatus includes a processor and a memory storing a program which, when executed by the processor, causes the information processing apparatus to execute acquisition processing of acquiring posted information from a first user, execute determination processing of determining whether the posted information of the first user is considered to be defamation, and execute notification processing of notifying, based on a determination result of the determination processing, a notification to a second user associated in advance with the first user.

### BACKGROUND

### Field of the Technology

The present disclosure relates to an information processing apparatus and an information processing method.

### Description of the Related Art

With the spread of social networking services (SNS), the number of bullying incidents on the Internet has been on the rise year by year. Japanese Patent Laid-Open No. 2004-246760 discloses an electronic bulletin board monitoring system that enables a monitoring person to immediately prevent posting on an electronic bulletin board when there is posted information that is not suitable for posting on the bulletin board, which can prevent unsuitable posted information from being posted for a long time.

Parents of children who use an SNS feel anxious about bullying of their children on the Internet. Thus, there is fear that when there is a post that is not suitable for posting, such as defamation that leads to bullying, a parent is not aware that the child has become a perpetrator or a victim if the monitoring person of the SNS deletes the unsuitable post.

### SUMMARY

The present disclosure provides an information processing apparatus that, when there is a post that leads to bullying on an SNS, notifies information regarding the post to an appropriate notification destination.

An information processing apparatus according to the present disclosure includes: a processor, and a memory storing a program which, when executed by the processor, causes the information processing apparatus to execute acquisition processing of acquiring posted information from a first user, execute determination processing of determining whether the posted information of the first user is considered to be defamation, and execute notification processing of notifying, based on a determination result of the determination processing, a notification to a second user associated in advance with the first user.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a notification system according to a first embodiment.

FIG. 2 is a diagram illustrating hardware configurations of a server and a terminal.

FIG. 3 is a diagram illustrating functional configurations of the server and the terminal according to the first embodiment.

FIG. 4 is a flowchart illustrating notification processing for a post that is considered to be defamation.

FIG. 5 is a diagram illustrating a configuration of a notification system according to a second embodiment.

FIG. 6 is a diagram illustrating a functional configuration of a terminal according to the second embodiment.

### DESCRIPTION OF THE EMBODIMENTS

### First Embodiment

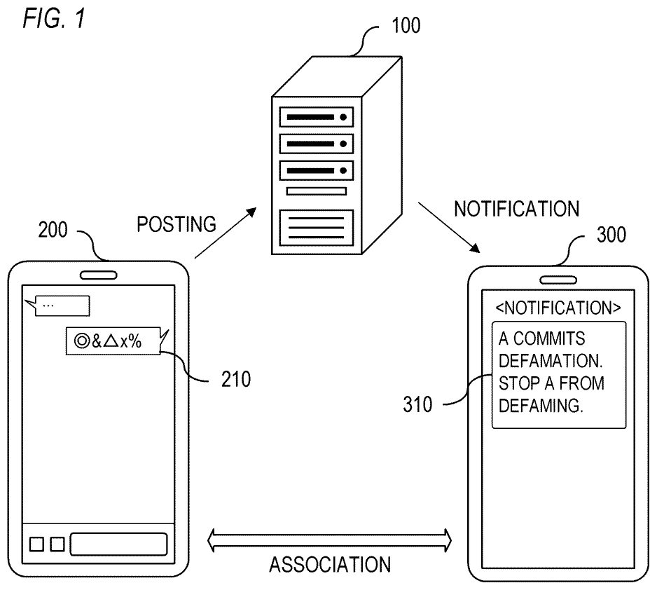

Hereinafter, embodiments of the present disclosure will be described with reference to the drawings. FIG. 1 is a diagram illustrating a configuration of a notification system according to a first embodiment. The notification system according to the first embodiment includes a server 100, a terminal 200, and a terminal 300. The server 100 is an example of an information processing apparatus according to the present disclosure.

The server 100 is a management server that provides an SNS service and accepts posts from a plurality of users. The server 100 accepts a post from a poster (corresponding to a first user). The server 100 can publish a posted content from the poster to a user of the SNS or transmit the posted content to a certain user designated by the poster.

The server 100 determines whether the posted content by the poster is considered to be defamation. Based on the determination result, the server 100, for example, provides a predetermined notification regarding the post of the poster to a user (corresponding to a second user) associated in advance with the poster. For example, when the poster makes a post 210 that is considered to be defamation of another person, the server 100 provides a notification 310 to prompt the user associated in advance with the poster to stop the poster from posting because the poster is committing defamation.

The terminal 200 is a terminal used by the poster to make posts on the SNS. The terminal 300 is a terminal used by a user who receives the notification from the server 100 to receive the notification. The user who receives the notification from the server 100 is, for example, the user associated in advance with the poster. The user associated in advance with the poster is hereinafter also described as a poster's parent user. The poster's parent user may be a user in the position of a guardian of the poster. The poster's parent user can be, for example, a user set by a parental control function for restricting the use of the terminal 200 used by the poster.

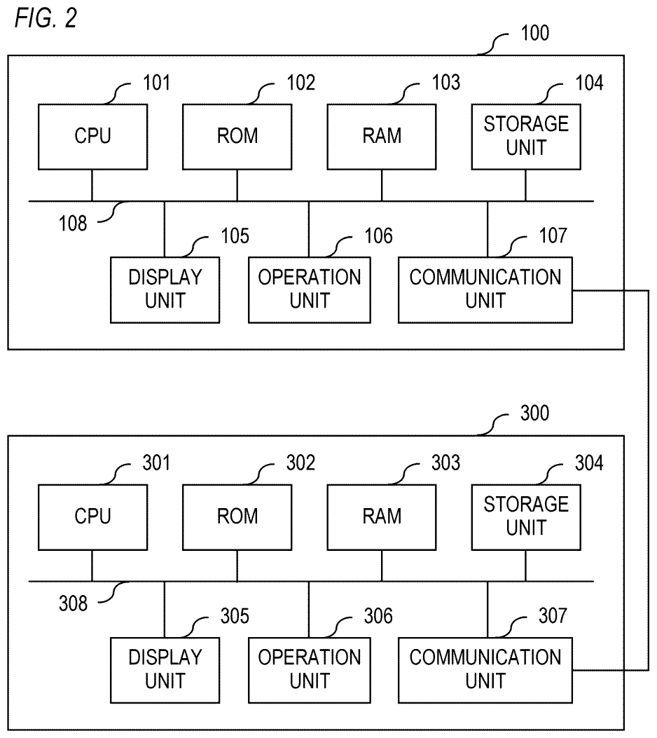

FIG. 2 is a diagram illustrating hardware configurations of the server 100 and the terminal 300. Since the hardware configuration of the terminal 200 is the same as the hardware configuration of the terminal 300, the description thereof will be omitted.

The server 100 includes a CPU 101, a read-only memory (ROM) 102, a random-access memory (RAM) 103, a storage unit 104, a display unit 105, an operation unit 106, and a communication unit 107. The components included in the server 100 communicate with each other via a bus 108.

The CPU 101 is a processor that controls the server 100. The CPU 101 reads computer programs stored in the ROM 102 and the storage unit 104 into the RAM 103 and executes the computer programs, thereby executing various processing of the server 100.

The ROM 102 is a nonvolatile memory that stores a basic program, such as an operating system (OS), initial data, and the like. The RAM 103 is a volatile memory used as a storage area for loading a program, a work area for executing a program, and a buffer for temporarily holding data.

The storage unit 104 is, for example, a hard disk drive that is built in or externally attached to the server 100, or a memory card. The storage unit 104 stores a computer program for implementing the function of the server 100. The storage unit 104 stores posted information from the poster. The storage unit 104 stores the poster and the poster's parent user in association with each other.

The display unit 105 is, for example, a liquid crystal display or an LED display. The display unit 105 displays a user interface and the like for the user to provide an instruction to the server 100. The operation unit 106 receives an operation to the server 100. The operation unit 106 is an operation member, such as a keyboard, a mouse, and a touch panel.

The communication unit 107 is a communication interface for communicating with an external device, such as the terminal 200 and the terminal 300, via the Internet or the like. The communication unit 107 can receive the posted information by the poster from the terminal 200. When a post from the poster is considered to be defamation, the communication unit 107 can transmit the notification to the terminal 300 of a user of a notification destination.

The terminal 300 may be any device that can use the SNS through connection to the server 100. The terminal 300 is, for example, a smartphone, a tablet, or a personal computer (PC). The terminal 300 includes a CPU 301, a ROM 302, a RAM 303, a storage unit 304, a display unit 305, an operation unit 306, and a communication unit 307. The components included in the terminal 300 communicate with each other via a bus 308.

The CPU 301 is a processor that controls the terminal 300. The CPU 301 reads computer programs stored in the ROM 302 and the storage unit 304 into the RAM 303 and executes the computer programs, thereby executing various processing of the terminal 300.

The ROM 302 is a nonvolatile memory that stores a basic program, such as an OS, initial data, and the like. The RAM 303 is a volatile memory used as a storage area for loading a program, a work area for executing a program, and a buffer for temporarily holding data.

The storage unit 304 is, for example, a hard disk drive that is built in or externally attached to the terminal 300, or a memory card. The storage unit 304 stores a computer program for implementing a function of the terminal 300.

The display unit 305 is, for example, a liquid crystal display or an LED display. The display unit 305 displays a user interface and the like for the user to provide an instruction to the terminal 300. The operation unit 306 receives an operation to the terminal 300. The operation unit 306 is an operation member, such as a keyboard, a mouse, and a touch panel.

The communication unit 307 is a communication interface for communicating with an external device, such as the server 100 and the terminal 200, via the Internet or the like.

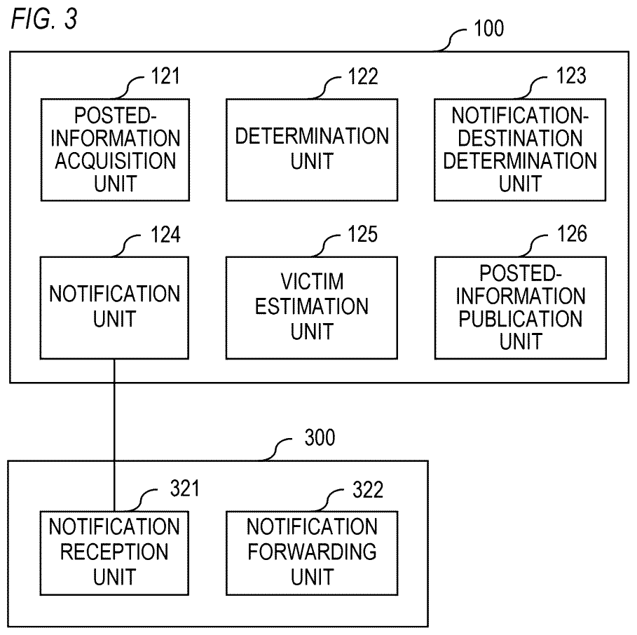

FIG. 3 is a diagram illustrating functional configurations of the server 100 and the terminal 300 according to the first embodiment. The server 100 includes a posted-information acquisition unit 121, a determination unit 122, a notification-destination determination unit 123, a notification unit 124, a victim estimation unit 125, and a posted-information publication unit 126. The processing of each functional unit is achieved by the CPU 101 executing a program corresponding to each functional unit. The terminal 300 includes a notification reception unit 321 and a notification forwarding unit 322. The processing of each functional unit is achieved by the CPU 301 executing a program corresponding to each functional unit.

The posted-information acquisition unit 121 accepts the posts from the plurality of users of the SNS. The posted-information acquisition unit 121 can acquire the posted information of the poster (first user). The posted information includes the posted content input by the poster to the terminal 200. The posted information may include information on a series of conversations (posts) between the poster and another user.

The determination unit 122 determines whether the posted information acquired by the posted-information acquisition unit 121 is considered to be defamation. For example, when a predetermined word is contained in the posted information, the determination unit 122 determines that the posted information of the poster is considered to be defamation. The predetermined word is a word and a phrase that may constitute defamation. The predetermined word is, for example, stored in the storage unit 104 of the server 100 in advance. A user can register, as the predetermined word, a word and a phrase that constitutes defamation, via the operation unit 106. The user may be a user of the SNS or an administrator on the SNS.

The determination unit 122 may also determine whether the posted information of the poster is considered to be defamation by using a trained model trained on words and conversations that are considered to be defamation. The words that are considered defamation are words and phrases that constitute defamation. The determination unit 122 can determine whether an input word is considered to be defamation by inputting a word contained in the posted information to the trained model.

The conversations that are considered to be defamation are conversations that are recognized, from interactions between the poster and the other user, that the poster is defaming the other user. The determination unit 122 can determine whether an input conversation is considered to be defamation by inputting the series of conversations between the poster and the other user to the trained model.

The determination unit 122 may determine whether the posted information of the poster is considered to be defamation based on posted information of the plurality of users including the poster. For example, the determination unit 122 can determine whether the posted information of the poster is considered to be defamation by inputting the posted information from the plurality of users to the trained model trained on the conversations that are considered to be defamation. The posted information (interactions between the poster and the other user) of the plurality of users may be collectively acquired from the terminal 200 of the poster, or may be acquired from the terminal 200 of each of the plurality of users.

The notification-destination determination unit 123 determines the notification destination to which the predetermined notification is provided when the posted information of the poster is considered to be defamation. The notification-destination determination unit 123 can determine the poster's parent user (second user) associated in advance with the poster as the notification destination.

The notification-destination determination unit 123 may determine the poster's parent user as the notification destination when the number of times the poster makes the post that is considered to be defamation exceeds a predetermined number of times. That is, the notification-destination determination unit 123 may notify the poster's parent user when the number of times the poster makes the post that is considered to be defamation exceeds the predetermined number of times.

The notification destination is not limited to the poster's parent user. The notification-destination determination unit 123 may determine, as the notification destination, at least one of the poster, a third-party organization that is not linked to the poster, a victim user who is a target of the defamation due to the posted information, a user associated in advance with the victim user, or a user in a group that can browse the posted information. The third-party organization is, for example, a bullying consultation desk, a school, the police, an administrator on the SNS service, or the like.

The victim user corresponds to a third user. The user associated in advance with the victim user corresponds to a fourth user, and is hereinafter also described as a victim's parent user. The victim's parent user may be a user in the position of a guardian of the victim. The victim's parent user can be, for example, a user set by a parental control function for restricting the use of the terminal 200 used by the victim. Information associating the victim with the victim's parent user is stored in the storage unit 104.

The notification-destination determination unit 123 may determine the notification destination according to the number of times the poster makes a post that is considered to be defamation. For example, in a case where a post that is considered to be defamation is a second instance, the notification-destination determination unit 123 determines the poster's parent user (second user) as the notification destination. In a case where a post that is considered to be defamation is a third instance, the notification-destination determination unit 123 determines the victim's parent user (fourth user) as the notification destination. In a case where a post that is considered to be defamation is a fifth instance, the notification-destination determination unit 123 determines the third-party organization as the notification destination.

The notification-destination determination unit 123 may also include the poster's parent user in the notification destination in a case where a post that is considered to be defamation is a third instance or more. The notification-destination determination unit 123 may also include the victim's parent user in the notification destination in a case where a post that is considered to be defamation is a fourth instance or more. As described above, the notification-destination determination unit 123 can determine a plurality of the notification destinations based on the number of posts that are considered to be defamation.

The notification-destination determination unit 123 may determine the notification destination based on a level of defamation of the posted information of the poster. The level of defamation can be set based on, for example, the number of defamatory words contained in the posted information, a level of defamation preset for each of the defamatory words, and the like.

For example, in a case where the level of defamation is set to three levels, level 1, level 2, and level 3, the notification-destination determination unit 123 can determine, at level 1, the notification destination as the poster's parent user. The notification-destination determination unit 123 can determine, at level 2, the victim's parent user as the notification destination, and at level 3 can determine the third-party organization as the notification destination.

The method by which the notification-destination determination unit 123 determines the notification destination is not limited to the above-described examples. The notification-destination determination unit 123 may determine the notification destination by combining the number of posts that are considered to be defamation and the level of defamation, or may determine the notification destination based on a setting registered in advance by a user.

The notification unit 124 provides the predetermined notification to the notification destination determined by the notification-destination determination unit 123. The notification unit 124 may transmit the predetermined notification to an e-mail address of the user of the notification destination by e-mail. The notification unit 124 may transmit the predetermined notification to an account of the user of the notification destination in an SNS application. In this case, the user of the notification destination can confirm the predetermined notification in the SNS application.

The predetermined notification contains content notifying that the posted information of the poster is considered to be defamation. The predetermined notification may contain a content of the posted information. The content of the predetermined notification may be different depending on the notification destinations, or may be the same regardless of the notification destinations.

A notification (corresponding to a first notification) to the poster's parent user may contain, for example, a content that prompts the poster's parent user to stop the poster from posting the defamatory language by the poster. A notification (corresponding to a second notification) to the poster may contain, for example, a content that prompts the poster to stop the post that is considered to be defamation. A notification (corresponding to a third notification) to the third-party organization may contain, for example, a content that prompts an investigation into bullying, a content prompting deletion of the post that is considered to be defamation, and the like.

A notification (corresponding to a fourth notification) to the victim user may contain, for example, a content that prompts the victim user to consult with someone about being a target of the defamation and being a target of bullying. A notification (corresponding to a fifth notification) to the victim's parent user may contain, for example, a content that prompts the victim's parent user to protect the victim from the defamation and bullying.

A notification (corresponding to a sixth notification) to a user in the group that can browse the posted information may contain, for example, a content that prompts the user to stop the poster from posting the defamation, a content that prompts the user to protect the victim from the defamation and bullying, or the like.

The victim estimation unit 125 estimates the victim user based on the posted information of the poster. The victim estimation unit 125 can estimate the victim user based on, for example, information indicating an address of the posted information. The information indicating the address of the posted information includes information of a user designated by the poster as a transmission destination of the posted information, information on a tag, such as a hash tag included in the posted information, and the like. The victim estimation unit 125 can estimate the victim user by using a trained model trained to identify a user who is a target of defamation due to a plurality of pieces of posted information by receiving the plurality of pieces of posted information.

The victim user (third user) may be able to set whether to permit the notification to the victim's parent user (fourth user). The notification-destination determination unit 123 may be enabled to select the victim's parent user as the notification destination in a case where the victim user permits the notification to the victim's parent user. In other words, the notification unit 124 may be enabled to make the notification (fifth notification) to the victim's parent user in a case where the victim user permits the notification to the victim's parent user. In a case where the victim user does not permit the notification to the victim's parent user, the notification to the victim's parent user is not made.

The posted-information publication unit 126 publishes the posted information from the user of the SNS acquired by the posted-information acquisition unit 121 on, for example, the Internet. The posted-information publication unit 126 may publish the posted information in the application that provides the SNS service. When the posted information of the poster is determined to be defamation, the posted-information publication unit 126 may perform control to not publish the posted information.

When the posted information of the poster is not published by the posted-information publication unit 126, the notification unit 124 notifies the victim user who is the target of defamation due to the posted information that the posted information has not been published because the posted information is considered to be defamation. The notification unit 124 transmits an e-mail to the victim user or notifies the victim user, via the SNS application, that the posted information has not been published because the posted information is considered to be defamation.

The notification reception unit 321 of the terminal 300 receives the predetermined notification from the notification unit 124. The display unit 305 of the terminal 300 displays a notification screen. The notification screen displays the predetermined notification from the server 100. The notification screen may display the posted information by the poster as it is.

The notification unit 124 may notify, to the terminal 300, information on another notification destination together with the predetermined notification. The notification screen displayed on the display unit 305 may include a user interface for notifying, to the other notification destination, the predetermined notification received from the notification unit 124. For example, the notification screen may include a button (hereinafter, also described as a forwarding button) for notifying the predetermined notification to the other notification destination, such as the third-party organization.

The notification forwarding unit 322 forwards the predetermined notification received from the notification unit 124 to the other notification destination by an operation of the user of the notification destination. For example, the user can operate the forwarding button displayed on the notification screen to forward the predetermined notification to the other notification destination.

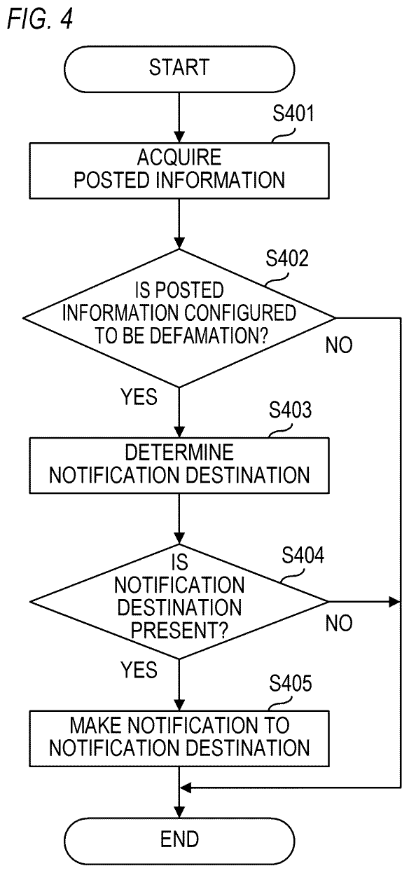

FIG. 4 is a flowchart illustrating notification processing for the post that is considered to be defamation. The processing illustrated in FIG. 4 is started, for example, by the poster posting to the SNS service provided by the server 100.

In step S401, the posted-information acquisition unit 121 acquires the posted information by the poster. The poster can use the application installed in the terminal 200 to post to the SNS service provided by the server 100. The posted-information acquisition unit 121 receives the posted information from the terminal 200 of the poster.

In step S402, the determination unit 122 determines whether the posted information acquired in step S401 is considered to be defamation. For example, when the predetermined word is contained in the posted information, the determination unit 122 determines that the posted information of the poster is considered to be defamation. The determination unit 122 can also determine whether the posted information of the poster is considered to be defamation by using the trained model trained on the words and the conversations that fall under defamation. The determination unit 122 can also determine whether the posted information of the poster is considered to be defamation based on the posted information of the plurality of users including the poster. When the posted information of the poster is considered to be defamation, the processing proceeds to step S403. When the posted information of the poster is not considered to be defamation, the processing illustrated in FIG. 4 ends.

In step S403, the notification-destination determination unit 123 determines the notification destination when the posted information of the poster is considered to be defamation. The notification-destination determination unit 123 can determine the poster's parent user (second user) associated in advance with the poster as the notification destination. When the number of times the poster makes the post that is considered to be defamation is less than or equal to the predetermined number of times, the notification-destination determination unit 123 may not set the notification destination, and the predetermined notification may not be provided.

The notification-destination determination unit 123 may also determine, as the notification destination, at least one of the poster, the third-party organization, the victim user, the victim's parent user, or a user in the group that is able to browse the posted information. The notification-destination determination unit 123 may set a plurality of the notification destinations.

In step S404, the notification unit 124 determines whether the notification destination determined in step S403 is present. When the notification destination is present, the processing proceeds to step S405. When the notification destination is not present, the process illustrated in FIG. 4 ends.

In step S405, the notification unit 124 provides the predetermined notification to the notification destination determined in step S403. The content of the predetermined notification may be the same regardless of the notification destinations, or may be different depending on the notification destinations. For example, the notification unit 124 provides the notification by transmitting an e-mail to the e-mail address of the user of the notification destination. The notification unit 124 may transmit the predetermined notification to the account of the user of the notification destination in the SNS application.

According to the present embodiment, when the post that is considered to be defamation is made, the server 100 can notify the information regarding the post to the poster's parent user associated in advance with the poster. The server 100 notifies the information regarding the post to an appropriate notification destination based on the number of times the poster makes the post that is considered to be defamation, the level of defamation of the posted information, or the like. In this manner, when there is a post that leads to bullying, on the SNS, the server 100 can notify the information regarding the post to an appropriate notification destination. The user who receives the notification can be made aware of the possibility that the poster is bullying as a perpetrator, and stop the behavior of the poster.

### Second Embodiment

In the first embodiment, the server 100 determines whether the posted information is considered to be defamation, and makes the predetermined notification to the determined notification destination. In a second embodiment, a terminal 200 of a poster determines whether posted information is considered to be defamation, and makes a predetermined notification to a determined notification destination.

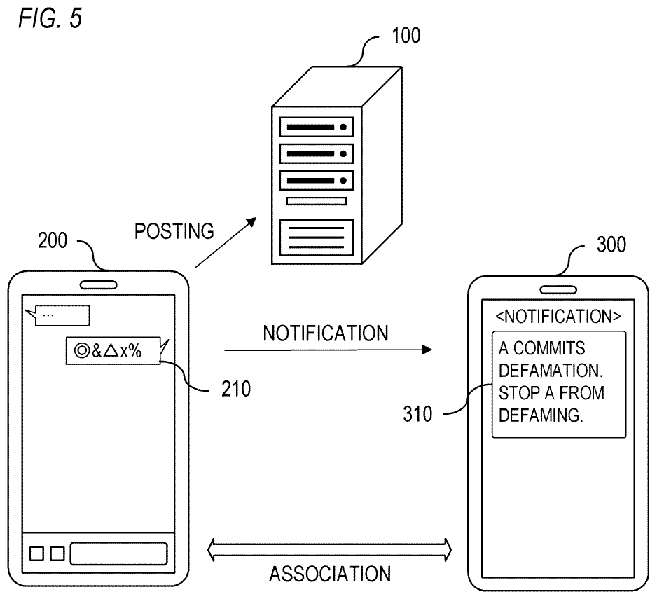

FIG. 5 is a diagram illustrating a configuration of a notification system according to the second embodiment. The notification system according to the second embodiment includes a server 100, the terminal 200, and a terminal 300. The server 100 according to the second embodiment provides an SNS service, and accepts a post from the poster (first user). In the second embodiment, a notification to a poster's parent user (second user) is made by the terminal 200 of the poster and not by the server 100. The terminal 200 according to the second embodiment is an example of the information processing apparatus according to the present disclosure.

The terminal 200 is a terminal used by the poster to make posts on the SNS. The terminal 200 determines whether a posted content by the poster is considered to be defamation. Based on the determination result, for example, the terminal 200 provides a notification regarding the post of the poster to the user (second user) associated in advance with the poster. Since the terminal 300 is the same as that in the first embodiment, the description thereof will be omitted.

Hardware configurations of the server 100, the terminal 200, and the terminal 300 are the same as those in the first embodiment. A storage unit 104 of the server 100 may not store information on association between the poster and the poster's parent user. A storage unit of the terminal 200 (a configuration corresponding to a storage unit 304 of the terminal 300) stores information from the terminal 200 of the user associated in advance with the poster. The storage unit of the terminal 200 stores information used for making the predetermined notification about the posted information of the poster from the terminal 200.

In the second embodiment, it is sufficient that the server 100 includes a posted-information acquisition unit 121 and a posted-information publication unit 126. The posted-information acquisition unit 121 receives a post from a user of the SNS. The posted-information publication unit 126 publishes posted information from the user of the SNS acquired by the posted-information acquisition unit 121.

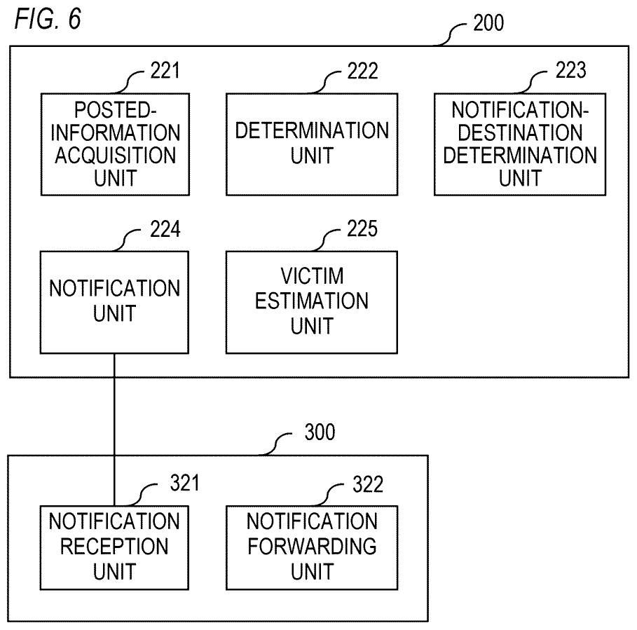

FIG. 6 is a diagram illustrating functional configurations of the terminal 200 and the terminal 300 according to the second embodiment. Similarly to the server 100 according to the first embodiment, the terminal 200 includes a posted-information acquisition unit 221, a determination unit 222, a notification-destination determination unit 223, a notification unit 224, and a victim estimation unit 225. The posted-information acquisition unit 221 acquires the posted information of the poster who makes the post from the terminal 200. The processing of the determination unit 222, the notification-destination determination unit 223, the notification unit 224, and the victim estimation unit 225 are the same as the processing of the determination unit 122, the notification-destination determination unit 123, the notification unit 124, and the victim estimation unit 125 of the server 100 according to the first embodiment. Since the functional configuration of the terminal 300 is the same as that in the first embodiment, the description thereof will be omitted.

A flow of notification processing of providing the predetermined notification from the terminal 200 to the terminal 300 is similar to the flow of the notification processing illustrated in FIG. 4. The processing executed by the posted-information acquisition unit 121, the determination unit 122, the notification-destination determination unit 123, the notification unit 124, and the victim estimation unit 125 are executed by the posted-information acquisition unit 221, the determination unit 222, the notification-destination determination unit 223, the notification unit 224, and the victim estimation unit 225 of the terminal 200, respectively.

According to the present embodiment, when the post that is considered to be defamation is made from the terminal 200, the terminal 200 can notify the information regarding the post to the poster's parent user associated in advance with the poster. Similarly to the server 100 according to the first embodiment, the terminal 200 notifies the information regarding the post to an appropriate notification destination based on the number of times the poster makes the post that is considered to be defamation, a level of defamation of the posted information, or the like. In this manner, when the poster makes a post that leads to bullying, the terminal 200 can notify the information regarding the post to an appropriate notification destination. The user who receives the notification can be made aware of the possibility that the poster is bullying as a perpetrator, and stop the behavior of the poster.

The above-described various types of control may be processing that is carried out by one hardware element (e.g., processor or circuit), or otherwise. Processing may be shared among a plurality of hardware elements (e.g., a plurality of processors, a plurality of circuits, or a combination of one or more processors and one or more circuits), thereby carrying out the control of the entire device.

The above-described processor includes general-purpose processors or dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The above-described embodiments are merely examples. Any configurations obtained by suitably modifying or changing some configurations of the embodiments within the scope of the subject matter of the present disclosure are also included in the present disclosure. The present disclosure also includes other configurations obtained by suitably combining various features of the above-described embodiments.

According to the present disclosure, when there is a post that leads to bullying on the SNS, the information regarding the post can be notified to an appropriate notification destination.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-228433, filed Dec. 25, 2024, which is hereby incorporated by reference herein in its entirety.

What is claimed is:

1. An information processing apparatus comprising:
a processor; and
a memory storing a program which, when executed by the processor, causes the information processing apparatus to:
execute acquisition processing of acquiring posted information from a first user,
execute determination processing of determining whether the posted information of the first user is considered to be defamation, and
execute notification processing of notifying, based on a determination result of the determination processing, a notification to a second user associated in advance with the first user.

2. The information processing apparatus according to claim 1, wherein in the determination processing, in a case where the posted information of the first user contains a predetermined word, it is determined that the posted information of the first user is considered to be defamation.

3. The information processing apparatus according to claim 1, wherein in the determination processing, whether the posted information of the first user is considered to be defamation is determined by using a trained model trained on words and conversations that are considered to be defamation.

4. The information processing apparatus according to claim 1, wherein in the notification processing, in a case where a number of times the first user makes a post that is considered to be defamation exceeds a predetermined number of times, the notification is made.

5. The information processing apparatus according to claim 1, wherein the second user is a user set by a parental control function for restricting use of a terminal used by the first user.

6. The information processing apparatus according to claim 1, wherein in the notification processing, an additional notification is made to the first user.

7. The information processing apparatus according to claim 1, wherein in the notification processing, a notification is made to a third-party organization that is not linked to the first user.

8. The information processing apparatus according to claim 1, wherein in the notification processing, a notification is made to a third user who is a target of defamation due to the posted information of the first user.

9. The information processing apparatus according to claim 8, wherein the information processing apparatus is further caused to execute estimation processing of estimating the third user.

10. The information processing apparatus according to claim 9, wherein in the estimation processing, the third user is estimated based on information indicating an address of the posted information of the first user.

11. The information processing apparatus according to claim 9, wherein in the estimation processing, the third user is estimated by using a trained model trained to identify a user who is a target of defamation due to a plurality of pieces of posted information by receiving the plurality of pieces of posted information.

12. The information processing apparatus according to claim 1, wherein in the notification processing, a notification is made to a fourth user associated in advance with a third user who is a target of defamation due to the posted information of the first user.

13. The information processing apparatus according to claim 12, wherein
the third user sets whether to permit the notification to the fourth user, and
in the notification processing, when the third user permits the notification to the fourth user, the notification is made to the fourth user.

14. The information processing apparatus according to claim 1, wherein in the notification processing, a notification is made to a user in a group that browses the posted information of the first user.

15. The information processing apparatus according to claim 1, wherein in the notification processing, a notification destination is determined according to a number of times the first user makes a post that is considered to be defamation.

16. The information processing apparatus according to claim 1, wherein in the notification processing, a notification destination is determined based on a level of defamation of the posted information of the first user.

17. The information processing apparatus according to claim 1, wherein a notification in the notification processing contains a content of the posted information of the first user.

18. The information processing apparatus according to claim 1, wherein a notification screen for displaying a notification in the notification processing includes a user interface for notifying the notification in the notification processing to another notification destination.

19. The information processing apparatus according to claim 1, further comprising a storage unit that stores the first user and the second user in association with each other.

20. The information processing apparatus according to claim 1, wherein the information processing apparatus is a server that accepts posts from a plurality of users.

21. The information processing apparatus according to claim 20, wherein in the determination processing, whether the posted information of the first user is considered to be defamation is determined based on posted information of the plurality of users including the first user.

22. The information processing apparatus according to claim 20, wherein the information processing apparatus is further configured to execute publication processing of publishing posted information from the plurality of users, and
wherein in the publication processing, in a case where the posted information of the first user is considered to be defamation, the posted information determined to be defamation is controlled not to be published.

23. The information processing apparatus according to claim 20, wherein in the notification processing, in a case where the posted information of the first user is not published, a third user who is a target of defamation due to the posted information of the first user is notified that the posted information of the first user has not been published because the posted information of the first user is considered to be defamation.

24. An information processing method comprising:
acquiring posted information from a first user,
determining whether the posted information of the first user is considered to be defamation, and
notifying, based on a determination result of the determination processing, a first notification to a second user associated in advance with the first user.

25. A non-transitory computer readable medium that stores a program, wherein the program causes a computer to execute an information processing method comprising:
acquiring posted information from a first user,
determining whether the posted information of the first user is considered to be defamation, and
notifying, based on a determination result of the determination processing, a first notification to a second user associated in advance with the first user.
